(19) United States
(12) Patent Application Publication
(10) Pub. No.: US 2022/0368136 A1
(43) Pub. Date: Nov. 17, 2022

(54) Discharge Device having a Short-Circuiting Element, and Discharge Method

(71) Applicant: Robert Bosch GmbH, Stuttgart (DE)

(72) Inventors: Denis Court, Korb (DE); Matthias Walter, Stuttgart (DE); Olaf Herrmann, Stuttgart-Feuerbach (DE); Roman Di Santo, Stuttgart (DE); Sebastian Krieger, Ulm (DE)

(21) Appl. No.: 17/741,779

(22) Filed: May 11, 2022

(30) Foreign Application Priority Data
May 14, 2021 (DE) 10 2021 204 914.1

(51) Int. Cl. H02J 7/00; H01M 10/44

(52) U.S. Cl. CPC H02J 7/0013; H01M 10/441

(57) ABSTRACT

A discharge device for discharging a plurality of battery cells having an unknown state-of charge is disclosed. The discharge device includes a contact-connection element for the electrical contact-connection of respective battery cells in the plurality of battery cells, and a short-circuiting element. The contact-connection element includes, for each individual battery cell in the plurality of battery cells, an electrical contact having a non-return device. Each of the non-return devices is configured to prevent any return flow of electricity from the respective battery cells, via the contact-connection element, into a battery cell which is assigned to the respective non-return device such that electricity is removed in a unidirectional manner from the respective battery cell. Respective electrical contacts of the contact-connection element are electrically coupled in the direction of flow of electricity, down-circuit of the respective non-return devices. The short-circuiting element is configured to short-circuit the plurality of battery cells.

This application claims priority under 35 U.S.C. § 119 to patent application no. DE 10 2021 204 914.1, filed on May 14, 2021 in Germany, the disclosure of which is incorporated herein by reference in its entirety.

### BACKGROUND

During the manufacture of electrochemical battery cells, a substantial quantity of battery cells are generated as production waste. Additionally, in the collection process for spent cells, a large quantity of battery cells are collected.

A proportion of these battery cells require discharging, for the purposes of a recycling process. To this end, in general, each individual battery cell is discharged to a very low electric voltage, generally close to zero volts.

The background to the present disclosure is a breakdown process, which is executed for the recycling of cell constituents of battery cells. In a breakdown process of this type, as a result of electrochemical reaction energy, unwanted chemical reactions can occur, which can damage a processing installation, generate chemical by-products which are difficult to control, and additionally alter the chemical purity of constituent substances, such that the value of the resulting recycling material is impaired.

Under ideal circumstances, only completely electrochemically discharged battery cells will undergo a breakdown process.

Particularly high-energy battery cells such as, for example, lithium-ion battery cells, generally assume a residual energy content of undefined magnitude.

Any discharging of individual battery cells is technically difficult on the grounds that, in general, industrial converters only operate with effect from a high voltage, for example 100 V, which significantly exceeds the voltage of an individual battery cell.

In battery cells which are to be recycled, a charge content and a cell voltage, together with an electrical behavior of cell material such as, for example, an internal resistance and a double-layer capacitance, are undefined. For this reason, it is not possible for battery cells simply to be connected in series, and thus achieve a higher voltage, on the grounds that, during a subsequent discharging process, individual battery cells would achieve a zero voltage, and a residual charge, and consequently a residual voltage, would thus remain on a plurality of battery cells.

Parallel connection would not fulfil the requirement for a voltage increase and, on the grounds of the undefined voltage level of the individual battery cells, is not possible without further measures.

In order to prevent any regeneration of discharged battery cells, the battery cells can be short-circuited, such that the latter are irreversibly damaged.

### SUMMARY

In the context of the present disclosure, a discharge device and a discharge method are proposed for discharging a plurality of battery cells with an unknown state-of-charge, having the characteristics described below. Further features and details of the disclosure proceed from the description below as well as the drawings. Naturally, features and details described with reference to the discharge device according to the disclosure also apply to the discharge method according to the disclosure, and vice versa, such that, with respect to disclosure, reciprocal reference to individual aspects of the disclosure can be applied in all cases.

The proposed disclosure is intended to provide a possibility for discharging a plurality of battery cells having an unknown state-of-charge. In particular, the proposed disclosure is intended to discharge battery cells, and to prevent any regeneration of battery cells.

According to a first aspect of the proposed disclosure, a discharge device is thus proposed for discharging a plurality of battery cells having an unknown state-of-charge. The discharge device comprises a contact-connection element for the electrical contact-connection of respective battery cells in the plurality of battery cells, and a short-circuiting element. The contact-connection element comprises, for each individual battery cell in the plurality of battery cells, an electrical contact having a non-return device, wherein each of the non-return devices is configured to prevent any return flow of electricity from the respective battery cells, via the contact-connection element, into a battery cell which is assigned to the respective non-return device, such that electricity is removed in a unidirectional manner from the respective battery cell. Respective electrical contacts of the contact-connection element are electrically coupled in the direction of flow of electricity, down-circuit of the respective non-return devices. The short-circuiting element is configured to short-circuit the plurality of battery cells.

In the context of the proposed disclosure, the state-of-charge is to be understood as the electric voltage or current strength which is delivered by a battery cell.

In the context of the proposed disclosure, an electrical contact is to be understood as an electrically conductive element such as, for example, a wire or a cable.

In the context of the proposed disclosure, a non-return device is to be understood as a component which prevents any return flow of electricity or electric current, flowing out of a battery cell, back into the battery cell. A non-return device thus ensures a unidirectional discharge of electricity from a battery cell, and prevents any exchange of electricity between different battery cells.

The proposed discharge device is based upon a contact-connection element having a plurality of electrical contacts and a short-circuiting element such that, by way of the contact-connection element, respective battery cells in a plurality of battery cells can be electrically contact-connected in a mutually independent or individual manner by way of the contact-connection element. The proposed discharge device thus permits the evacuation of electricity stored in the respective battery cells, and particularly permits each of the battery cells to be brought to a state of deep discharge. The proposed discharge device thus permits a plurality of battery cells to be discharged in combination, or in a single and simultaneous process step.

By way of the short-circuiting element provided according to the disclosure, it is possible for respective battery cells which are discharged by the discharge device to be short-circuited, such that the latter are irreversibly damaged, thereby preventing any regeneration of battery cells further to the discharge thereof. To this end, the short-circuiting element can electrically couple different electric poles of the respective battery cells, or can electrically couple one pole of a respective battery cell to a ground pole of the discharge device, thereby constituting a short-circuit to ground.

Respective electrical contacts of the contact-connection element provided according to the disclosure, for the electrical contact-connection of respective battery cells, can comprise an electrical interface such as, for example, a metal plate or a clamping device. To this end, the clamping device can incorporate a mechanical spring element, by way of which a respective electrical contact is clamped to a respective battery cell.

By way of the plurality of electrical contacts of the contact-connection element of the proposed discharge device, electricity or electric current can be evacuated from a respective battery cell in a plurality of battery cells, independently of other respective battery cells in the plurality of battery cells, and fed, for example, to an electric current store or an electrical load. By way of the proposed discharge device, electricity flowing from the respective battery cells can thus be evacuated in the direction of flow, down-circuit of the non-return devices provided according to the disclosure, and converted, for example, into a specific voltage.

By way of the plurality of non-return devices provided according to the disclosure, respective battery cells can be electrically discharged in an individual or mutually independent manner. The non-return devices prevent any exchange of electricity between respective battery cells, such that electricity discharged from the respective battery cells is exclusively discharged via the contact-connection element and is fed, for example, to an electrical load. Accordingly, it is possible for the state of charge of various battery cells which are electrically coupled to the proposed discharge system to vary or differ. In particular, the non-return devices provided according to the disclosure permit the complete discharging of individual battery cells, while other battery cells are still being discharged. To this end, non-return devices can galvanically isolate different battery cells, for example from one another.

It can be provided that the respective non-return devices of the contact-connection element are configured in the form of diodes and/or transistors.

The short-circuiting element provided according to the disclosure can comprise one or more plates of an electrically conductive material and/or electrical contacts for the contact-connection of electric poles of the respective battery cells and/or of a ground pole of the discharge device.

In particular, the short-circuiting element can comprise two plates of an electrically conductive material, which can be electrically coupled by way of an electrical coupler. Correspondingly, a first plate can be arranged on one pole side of the respective battery cells, and a second plate can be arranged on an opposing pole side such that, by the electrical coupling of the first plate and the second plate by way of the electrical coupler, a short-circuit is constituted.

The contact-connection element and the short-circuiting element can be connected in a mutually pivoting arrangement, such that the latter can move relative to one another in specific trajectories, thereby preventing any short-circuiting of the contact-connection element by the short-circuiting element. Alternatively, the contact-connection element and the short-circuiting element can be configured as an integral component such that, by way of the short-circuiting element, electrical contacts of the contact-connection element can be coupled with the corresponding opposing electric poles of respective battery cells, in order to constitute a short-circuit.

It can further be provided that the proposed discharge device incorporates a location device, wherein the location device is configured to arrange respective battery cells which are introduced into the location device in a spatial pattern which corresponds to a spatial pattern of electrical contacts of the contact-connection element, such that all of the battery cells arranged in the location device can be electrically contact-connected by way of the contact-connection element.

In order to permit a rapid and simple discharging of a plurality of battery cells, a location device is appropriate which compels the battery cells into a specific spatial arrangement, such that battery cells can be moved precisely onto respective electrical contacts of the contact-connection element, or electrical contacts of the contact-connection element can be moved precisely onto the respective battery cells. To this end, the location device and the contact-connection element can be connected to one another in a relatively moveable manner, particularly by way of a hinged mechanism.

It can further be provided that the discharge device comprises a compression element, which is configured to move respective battery cells which are introduced into the discharge device into the spatial pattern, and to permit the electrical contact-connection of all the battery cells by way of the contact-connection element. By way of a compression element, an exact positioning of respective battery cells and/or a reliable electrical contact with the contact-connection element can be ensured. To this end, the compression element can comprise, for example, a weight, particularly in a hinged arrangement, and/or a number of spring elements, by way of which respective battery cells are compressed against respective electrical contacts of the contact-connection element, in order to constitute a reliable electrical coupling. Alternatively or additionally, the compression element, for example by way of a pump, can generate an overpressure or a negative pressure, in order to orient the battery cells and/or the contact-connection element.

It can further be provided that the location device incorporates a plurality of locating carriers, which are arranged in an alternating manner on the contact-connection element, in order to permit the electrical contact-connection of battery cells which are arranged on a respective locating carrier, by way of the contact-connection element.

By way of different locating carriers, a stock of battery cells can be constituted for storage, which can be successively delivered to the proposed discharge device, thus permitting full capacity utilization at all times, and a correspondingly efficient operation of the discharge device. A locating carrier can be, for example, a plug-in tray, or any other transportable carrier. In particular, a locating carrier can incorporate locators for battery cells, into which respective battery cells can be introduced horizontally or vertically, and secured in position therein. Optionally, a locating carrier can comprise an enclosed shell, which can be opened as required for the purposes of loading or unloading and which, in the closed position, protects the surroundings against damage by fire or explosion associated with burning or exploding battery cells.

It can further be provided that the short-circuiting element incorporates a plurality of cut-outs for the feedthrough of electrical contacts of the contact-connection element.

By way of a plurality of cut-outs, the short-circuiting element can be arranged between the contact-connection element and respective battery cells, such that the short-circuit device can remain in the discharge device, without the removal of the contact-connection element, and can be employed therein for the short-circuiting of battery cells. To this end, the short-circuiting element can be moved, for example, between a spaced position from the battery cells and a contact-connected position with the battery cells.

It can further be provided that the respective cut-outs assume a cross-section which is smaller than a cross-section of an electric pole of a respective battery cell.

By way of cut-outs, the cross-section of which is smaller than the cross-section of an electric pole of a respective battery cell, the cut-out can be employed as a guide for an electrical contact of the contact-connection element which is led through the recess, such that a respective electrical contact is reliably contact-connected with a corresponding pole of a respective battery cell.

It can further be provided the short-circuiting element is pivotable between a first specific position relative to the contact-connection element and a second specific position relative to the contact-connection element.

By way of a short-circuiting element which is pivotable between two positions relative to the contact-connection element, a simple, rapid and accurate or reliable electrical coupling of the short-circuiting element with respective battery cells can be achieved. By way of the two specific positions, the short-circuiting element moves in a specific trajectory between an electrically isolating position of the short-circuit element and an electrically coupling position of the short-circuiting element.

Particularly in combination with a location device, which is arranged in a specific position on the discharge device, the short-circuiting element can be moved relative to the location device, such that battery cells introduced into the location device can be oriented in a manner wherein the poles thereof are located in the second position, and the short-circuiting element electrically contact-connects the battery cells, when the short-circuiting element is located in the second position.

It can further be provided that the short-circuiting element comprises a plurality of electrical short-circuiting contacts for the electrical coupling of the short-circuiting element with respective battery cells, wherein the electrical short-circuiting contacts are moveable between a first position, in which the electrical short-circuiting contacts are electrically isolated from the respective battery cells, and a second position, in which the electrical short-circuiting contacts are electrically coupled with the respective battery cells.

By way of moveable electrical short-circuiting contacts, a short-circuit can be constituted and subsequently interrupted in a simple manner, for example by way of a lifting/lowering device such as, for example, a lever or a worm drive.

It can further be provided that the short-circuiting element comprises an actuator, by way of which the short-circuiting element and/or the short-circuiting contacts is/are moveable between the first position and the second position.

By way of an actuator such as, for example, an electric motor which is mechanically coupled, for example, to a mechanical lifting/lowering device such as, for example, a lever or a worm drive, an automatic and controlled movement of the short-circuiting element or the short-circuiting contacts can be achieved.

It can further be provided that the discharge device incorporates a control device and a voltage sensor, wherein the control device is configured to actuate the actuator, in order to move the short-circuiting element and/or the short-circuiting contacts from the first position to the second position and to short-circuit respective battery cells, in the event that the voltage delivered by the battery cells undershoots a specified short-circuiting threshold value.

By way of a control device for controlling an actuator for the movement of the short-circuiting element and/or the short-circuiting contacts, automatic control of the discharge device can be achieved, wherein respective battery cells are discharged to a specific state-of-charge, and are short-circuited thereafter. Individual battery cells can thus be short-circuited in a mutually temporally independent manner, wherein individual short-circuiting contacts are moved, or all the battery cells can be simultaneously short-circuited, wherein all the short-circuiting contacts are moved in combination.

It can further be provided that the discharge device incorporates a cooling device, which is thermally coupled to the short-circuiting element and/or the battery cells, in order to evacuate thermal energy generated in conjunction with a short-circuit from the discharge device.

A cooling device such as, for example, a plate around which a coolant flows and which is thermally coupled to a heat sink, and/or which comprises cooling ribs, can prevent any heat-up of the discharge device or the short-circuiting element in excess of a critical temperature.

It can further be provided that the short-circuiting element incorporates a current source, by way of which electrical energy can be introduced into a current circuit which is short-circuited by way of the short-circuiting element.

By way of a current source, a particularly strong short-circuit current can be delivered, which will destroy the respective battery cells, even if the latter are no longer capable of delivering a strong short-circuit current themselves.

According to a second aspect, the proposed disclosure relates to a discharge method for discharging a plurality of battery cells having an unknown state-of-charge. The discharge method comprises an arrangement step, in which the plurality of battery cells are arranged in accordance with a potential configuration of the proposed discharge device, a contact-connection step, in which the plurality of battery cells are electrically contact-connected by way of a contact-connection element of the discharge device, wherein the contact-connection element, for each individual battery cell in the plurality of battery cells, comprises an electrical contact having a non-return device, wherein the non-return device prevents any return flow of electricity which is conducted by the contact-connection element back into the respective battery cell, such that electricity is unidirectionally removed from the respective battery cell, and wherein respective electrical contacts of the contact-connection element are electrically coupled in the direction of flow of electricity, down-circuit of the respective non-return devices. The discharge method further comprises a short-circuiting step, wherein the plurality of battery cells are short-circuited by way of a short-circuiting element of the discharge device.

### BRIEF DESCRIPTION OF THE DRAWINGS

Further advantages, features and details of the disclosure proceed from the following description, in which exemplary embodiments of the disclosure are described in detail with reference to the drawings. Features mentioned in the description can be essential to the disclosure, either individually per se, or in any arbitrary combination.

In the drawings:

FIG. 1 shows a schematic representation of a potential configuration of the proposed discharge device,

FIG. 2 shows a side view of the discharge device according to FIG. 1,

FIG. 3 shows the discharge device according to FIG. 1, in a first state,

FIG. 4 shows the discharge device according to FIG. 1, in a second state,

FIG. 5 shows an overhead view of the discharge device according to FIG. 1,

FIG. 6 shows a schematic representation of a potential configuration of the proposed discharge method.

### DETAILED DESCRIPTION

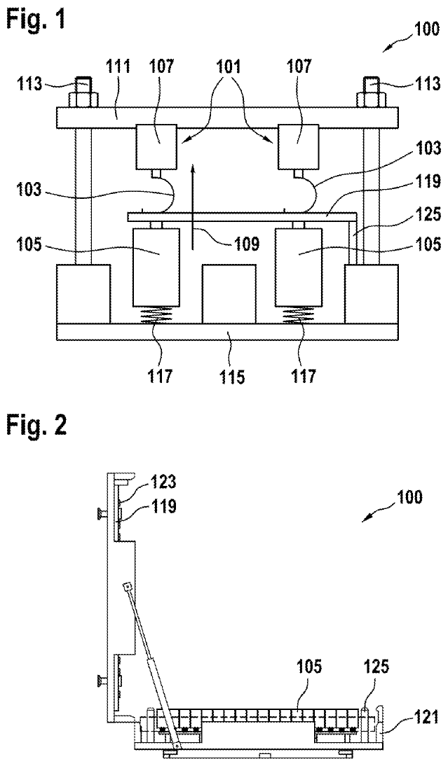

FIG. 1 represents a discharge device 100. The discharge device 100 comprises a contact-connection element 101 having electrical contacts 103 for the electrical contact-connection of battery cells 105.

Each of the electrical contacts 103 comprises a non-return device 107, which prevents any flow of electricity from the contact-connection element 101 in the direction of the respective battery cells 105, and correspondingly dictates a unidirectional discharge, as indicated by the arrow 109.

In the present case, the non-return devices 107 are arranged between the respective battery cells 105 and electrical conductors 111 for the evacuation of electrical energy from the contact-connection element 101.

The electrical conductors 111 are electrically coupled to optional electrical interfaces 113 for the electrical coupling of the discharge device, for example, with an electrical load such as, for example, a power supply grid.

In order to prevent any heat-up of the discharge device 100 in excess of a critical value, the discharge device 100 optionally comprises a cooling element 115 such as, for example, a metal plate, around which a coolant flows and which is in thermal contact with a heat sink.

FIG. 1 further represents optional compression elements 117 in the form of mechanical springs, by way of which the battery cells 105 are compressed against the electrical contacts 103 of the contact-connection element 101, in order to constitute a reliable electrical coupling.

FIG. 1 further represents a short-circuiting element 119, by way of which the battery cells 105 are short-circuited or are short-circuitable. By way of this short-circuit, the battery cells 105 are irreversibly destroyed, and cannot be regenerated.

For the short-circuiting of battery cells, the short-circuiting element 119 can electrically couple the respective poles of battery cells 105, or can electrically couple a respective pole of the battery cells to ground, particularly to a ground constituted by a housing of the discharge device 100.

For the electrical coupling of respective battery cells 105 with a ground of the discharge device 100, the discharge device 100 comprises an optional ground point 125, to which the short-circuiting element 119 is automatically electrically coupled, when the latter is electrically coupled with the poles of the respective battery cells 105.

For the supply of an AC voltage load, the discharge device can be connected to a DC-AC converter, or can optionally comprise a DC-AC converter.

FIG. 2 represents a side view of the discharge device 100. It can clearly be seen here that the short-circuiting element 119, with its short-circuiting contacts 123, is pivotably coupled to a location device 121 of the discharge device, such that the short-circuiting element 119 is moveable in a specific trajectory between two specific end positions relative to the location device 121 and the battery cells 105 arranged therein.

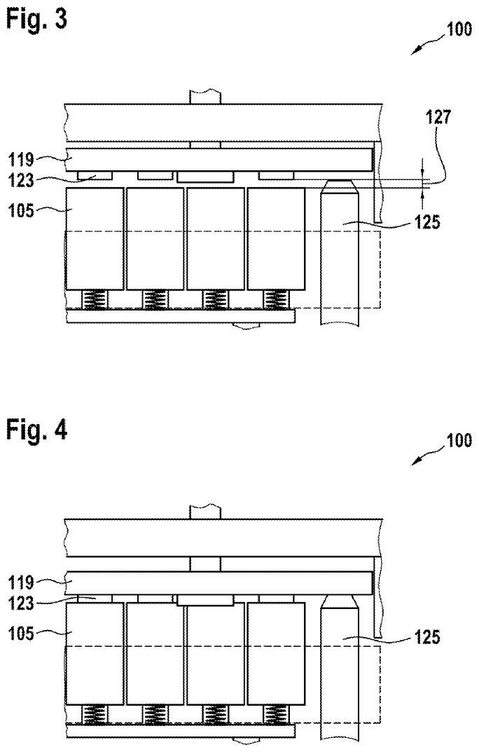

FIG. 3 represents a form of embodiment of the discharge device 100, in a state in which the short-circuiting contacts 123 of the short-circuiting element 119 are spaced from respective poles of the battery cells 105, such that the battery cells 105 are not short-circuited and, for example, are discharged via the contact-connection element 101.

In the present case, a clearance between the short-circuiting contacts 123 of the short-circuiting element 119 is, for example, 10 millimeters, as indicated by arrows 127.

In FIG. 4, the short-circuiting element 119 is in electrical contact with the battery cells and with a ground point 125 of the discharge device 100, such that the battery cells 105 are short-circuited to ground. The battery cells 105 are thus rendered unusable by the short-circuiting element 119, and can be safely delivered to a further processing step such as, for example, a crusher.

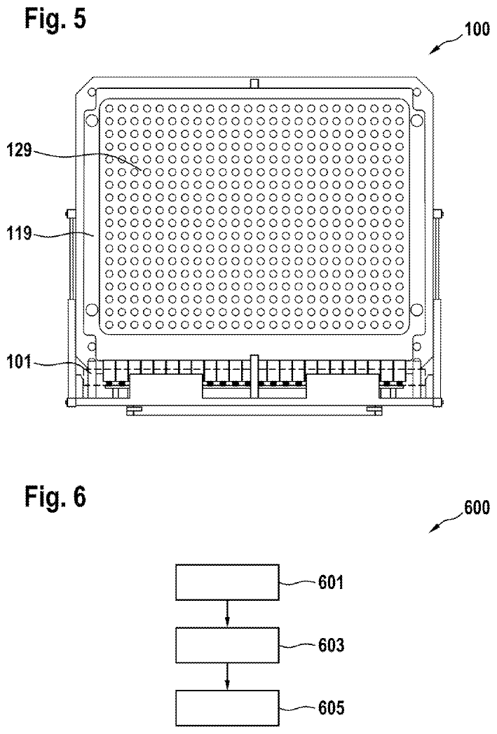

FIG. 5 represents an overhead view of the discharge device 100. It can be seen here that the short-circuiting element 119 comprises a plurality of cut-outs 129 for the feedthrough of electrical contacts of the contact-connection element 101. Accordingly, the short-circuiting element 119 can be moved independently of the contact-connection element 101 on the discharge device 100, such that any removal or fitting of the short-circuiting element 119, or any exchange of the contact-connection element 101 with the short-circuiting element 119 can be omitted. Conversely, the cut-outs 129 permit the parallel or simultaneous presence of the short-circuiting element 119 and the contact-connection element 101 in or on the discharge device 100.

FIG. 6 represents a discharge method 600. The discharge method 600 comprises an arrangement step 601, in which the plurality of battery cells are arranged in accordance with a potential configuration of the proposed discharge device, a contact-connection step 603, in which the plurality of battery cells are electrically contact-connected by way of a contact-connection element of the discharge device, wherein the contact-connection element, for each individual battery cell in the plurality of battery cells, comprises an electrical contact having a non-return device, wherein the non-return device prevents any return flow of electricity which is conducted by the contact-connection element back into the respective battery cell, such that electricity is unidirectionally removed from the respective battery cell, and wherein respective electrical contacts of the contact-connection element are electrically coupled in the direction of flow of electricity, down-circuit of the respective non-return devices. The discharge method further comprises a short-circuiting step 605, wherein the plurality of battery cells are short-circuited by way of a short-circuiting element of the discharge device.

What is claimed is:

1. A discharge device for discharging a plurality of battery cells having an unknown state-of-charge, comprising:
a contact-connection element configured for electrical contact-connection of respective battery cells in the plurality of battery cells, and
a short-circuiting element,
wherein the contact-connection element comprises, for each individual battery cell in the plurality of battery cells, an electrical contact having a non-return device,
wherein each of the non-return devices is configured to prevent any return flow of electricity from the respective battery cells, via the contact-connection element, into a battery cell which is assigned to the respective non-return device such that electricity is removed in a unidirectional manner from the respective battery cell,
wherein respective electrical contacts of the contact-connection element are electrically coupled in the direction of flow of electricity, down-circuit of the respective non-return devices, and
wherein the short-circuiting element is configured to short-circuit the plurality of battery cells.

2. The discharge device according to claim 1, wherein the short-circuiting element includes a plurality of cut-outs for the feedthrough of electrical contacts of the contact-connection element.

3. The discharge device according to claim 2, wherein the respective cut-outs assume a cross-section which is smaller than a cross-section of an electric pole of a respective battery cell.

4. The discharge device according to claim 1, wherein the short-circuiting element is pivotable between a first specific position relative to the contact-connection element and a second specific position relative to the contact-connection element.

5. The discharge device according to claim 1, wherein:
the short-circuiting element comprises a plurality of electrical short-circuiting contacts configured for electrical coupling of the short-circuiting element with respective battery cells, and
the electrical short-circuiting contacts are moveable between a first position in which the electrical short-circuiting contacts are electrically isolated from the respective battery cells and a second position in which the electrical short-circuiting contacts are electrically coupled with the respective battery cells.

6. The discharge device according to claim 5, wherein the short-circuiting element comprises an actuator, by way of which the short-circuiting element and/or the short-circuiting contacts is/are moveable between the first position and the second position.

7. The discharge device according to claim 6, further comprising a control device and a voltage sensor, wherein:
the control device is configured to actuate the actuator in order to move the short-circuiting element and/or the short-circuiting contacts from the first position to the second position and short-circuit respective battery cells in the event that the voltage delivered by the battery cells undershoots a specified short-circuiting threshold value.

8. The discharge device according to claim 7, wherein the actuator is configured, firstly to move the contact-connection element into a position in which the electrical contacts of the contact-connection element are electrically isolated from the battery cells, and thereafter to move the short-circuiting element and/or the short-circuiting contacts from the first position to the second position.

9. A discharge device according to claim 1, wherein the discharge device includes a cooling device which is thermally coupled to the short-circuiting element and/or to the battery cells in order to evacuate thermal energy generated in conjunction with a short-circuit from the discharge device.

10. The discharge device according to claim 1, wherein the short-circuiting element includes a current source by way of which electrical energy can be introduced into a current circuit which is short-circuited by way of the short-circuiting element.

11. A method for discharging a plurality of battery cells having an unknown state-of-charge, comprising:
arranging the plurality of battery cells on the discharge device according to claim 1;
connecting the plurality of battery cells by way of the contact-connection element, wherein (i) the contact-connection element, for each individual battery cell in the plurality of battery cells includes an electrical contact having a non-return device, (ii) the non-return device is configured to prevent any return flow of electricity which is conducted by the contact-connection element back into the respective battery cell such that electricity is unidirectionally removed from the respective battery cell, and (iii) respective electrical contacts of the contact-connection element are electrically coupled in the direction of flow of electricity, down-circuit of the respective non-return devices; and
short-circuiting the plurality of battery cells by way of the short-circuiting element.
